(19) United States
(12) Patent Application Publication
(10) Pub. No.: US 2008/0022801 A1
(43) Pub. Date: Jan. 31, 2008

(54) Lubrication System for Driving Force Distributing and Transmitting Apparatus

(75) Inventors: Shinji KITAOKA, Toukai-shi (JP); Toru Inoue, Obu-shi (JP); Yukio Ueda, Toyoake-shi (JP); Satoshi Munakata, Nishikamo-gun (JP)

Correspondence Address: BUCHANAN, INGERSOLL & ROONEY PC, POST OFFICE BOX 1404, ALEXANDRIA, VA, 22313-1404, US

(73) Assignees: AISIN AI Co., Ltd., Nishio-shi (JP); TOYOTA JIDOSHA KABUSHIKI KAISHA, Toyota-shi (JP)

(21) Appl. No.: 11/779,313

(22) Filed: Jul. 18, 2007

(30) Foreign Application Priority Data
Jul. 28, 2006 (JP) 2006-206471

(51) Int. Cl. F16H 57/04; B60K 17/348

(52) U.S. Cl. 74/467; 74/606 A

(57) ABSTRACT

A lubrication system for driving force distributing and transmitting apparatus includes a case reserving lubrication fluid in a space provided at a bottom portion thereof, a rotational shaft rotationally supported by the case, a first oil seal provided between the case and the rotational shaft, an oil pump actuated by rotation of the rotational shaft, a lubrication fluid introducing passage directly supplying the pressurized lubrication fluid outputted by the oil pump to the first oil seal, and a lubrication fluid leading passage supplying the lubrication fluid pushed out via the first oil seal to a component to be lubricated.

### CROSS REFERENCE TO RELATED APPLICATIONS

This application is based on and claims priority under 35 U.S.C. § 119 with respect to Japanese Patent Application No. 2006-206471 filed on Jul. 28, 2006, the entire content of which is incorporated herein by reference.

### FIELD OF THE INVENTION

The present invention relates to a driving force distributing and transmitting apparatus having a passage supplying lubrication fluid to an oil seal.

### BACKGROUND

Driving force distributing and transmitting apparatus which distributes torque (i.e., torque from a motor or an engine, or the like) inputted from outside have been known.

Driving force distributing and transmitting apparatus distribute rotational force applied to an input shaft to an output shaft via plural gears and/or via a chain provided in a case in response to conditions to conduct rotational transmission between the input shaft and the output shaft.

In order to lubricate the gears and the chain which are sliding portions in the aforementioned driving force distributing and transmitting apparatus, generally, lubrication fluid is supplied to be reserved in a space at a bottom portion in the case in which the gears and the chain are housed. A portion of each of the gears and the chain is immersed in the lubrication fluid reserved in the space at the bottom portion in the case, the gears and the chain lift up the lubrication fluid in response to the rotation thereof, and lubricate sliding portions in the case.

For example, JPH08-091067A discloses a structure in which lubrication fluid is lifted using an oil lifting gear besides the gears and the chain. Further, according to JPH08-091067A, a lubrication fluid reservoir which supplies lubrication fluid to the oil lifting gear is provided above the space at the bottom portion in the case.

However, with the construction where the lubrication is conducted by only lifting the reserved lubrication fluid by the gears and the chain, the lubrication fluid cannot be lifted adequately at low speed rotation of the input shaft and the lubrication fluid is spattered to stay on an inner wall of the case, therefore making it difficult to lubricate the entire device evenly.

According to JP2003-130190A, an input shaft rotated by torque transmitted from outside a case is rotatably provided at the case via a bush which is outfitted to the input shaft, and a lubrication fluid passage extended to the bush and a lubrication fluid chamber which is in communication with the lubrication fluid passage are provided in a space at a bottom portion of the case. A gear geared with the input shaft is provided in the lubrication fluid chamber. The gear is stirred in the lubrication fluid chamber by the rotation of the input shaft to generate a flow in lubrication fluid. A fluid shielding member which covers the gear is provided above the gear. Upon the rotation of the input shaft, the lubrication fluid in the lubrication fluid chamber is agitated by the gear to generate the flow and thus to be guided to flow to the bush through the lubrication fluid passage. In those circumstances, at the high-speed rotation of the input shaft, the spattering of the lubrication fluid is prevented by the fluid shielding member which is provided above the gear when supplying the lubrication fluid to the bush.

With the construction described in JPH08-091067A, the space for the oil lifting gear and the lubrication fluid reservoir is required. Further, extra supply of the lubrication fluid is required to be reserved. With the constructions described in JPH08-091067A and JP2003-130190A, when the driving force distributing and transmitting apparatus is tilted, the level of the lubrication fluid in the lubrication fluid reservoir or in the space at the bottom portion is changed, and the lubrication may not be adequately conducted. Further, according to JPH08-091067A and JP2003-130190A, lubricated portions serve as rotational sliding portions.

A need thus exists for a driving force distributing and transmitting apparatus, which enables constant lubrication even when the driving force distributing and transmitting apparatus is tilted and which constantly supplies appropriate volume of lubrication fluid to an oil seal.

### SUMMARY OF THE INVENTION

In light of the foregoing, the present invention provides a lubrication system for driving force distributing and transmitting apparatus, which includes a case reserving lubrication fluid in a space provided at a bottom portion thereof, a rotational shaft rotationally supported by the case, a first oil seal provided between the case and the rotational shaft, an oil pump actuated by rotation of the rotational shaft, a lubrication fluid introducing passage directly supplying the pressurized lubrication fluid outputted by the oil pump to the first oil seal, and a lubrication fluid leading passage supplying the lubrication fluid pushed out via the first oil seal to a component to be lubricated.

According to another aspect of the present invention, a lubrication system for driving force distributing and transmitting apparatus includes a case reserving lubrication fluid in a space at a bottom thereof, an input shaft rotationally supported by the case, a first oil seal provided between the case and the input shaft, an oil pump actuated by rotation of the input shaft, a lubrication fluid introducing passage directly supplying the pressurized lubrication fluid outputted by the oil pump to the first oil seal, and a lubrication fluid leading passage supplying the lubrication fluid pushed out via the first oil seal to a component to be lubricated.

According to further aspect of the present invention, a lubrication system for a driving force distributing and transmitting apparatus includes a case reserving lubrication fluid in a space at a bottom thereof, an input shaft rotatably supported by the case and receiving a supply of the lubrication fluid via a first oil seal, a first output shaft rotatably supported by the case and receiving a supply of the lubrication fluid via a second oil seal, an oil pump actuated by a rotation of the input shaft or a second output shaft, a lubrication fluid introducing passage supplying pressurized lubrication fluid outputted from the oil pump directly to the first oil seal, and a lubrication fluid leading passage supplying the lubrication fluid pushed out via the first oil seal to the second oil seal.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross-sectional view of a driving force distributing and transmitting apparatus according to a first embodiment of the present invention.

FIG. 2 is a magnified view of a main portion of FIG. 1.

FIG. 3 is a cross-sectional view of a driving force distributing and transmitting apparatus according to a second embodiment of the present invention.

FIG. 4 is a cross-sectional view of a driving force distributing and transmitting apparatus according to a third embodiment of the present invention.

### DETAILED DESCRIPTION

Embodiments of the present invention will be explained with reference to illustrations of drawing figures as follows.

According to the embodiments of the present invention, a driving force distributing and transmitting apparatus is applied to a transfer for a four-wheel drive vehicle.

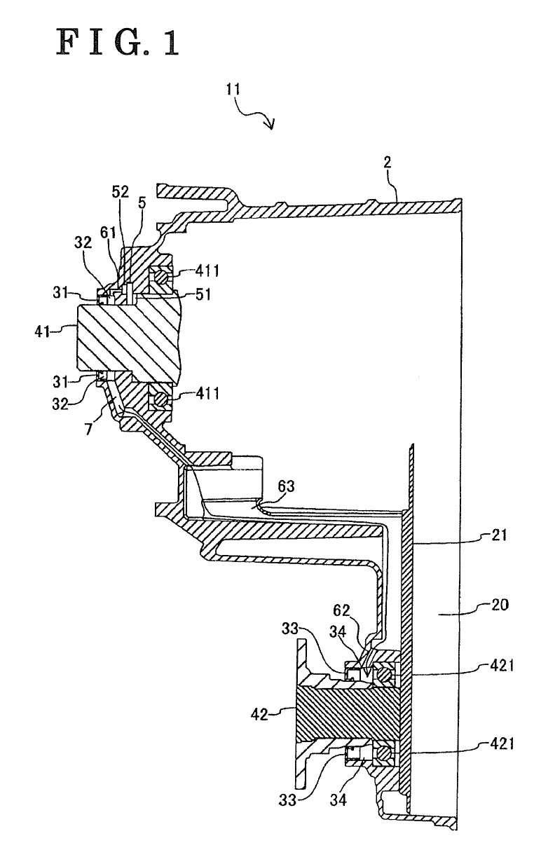

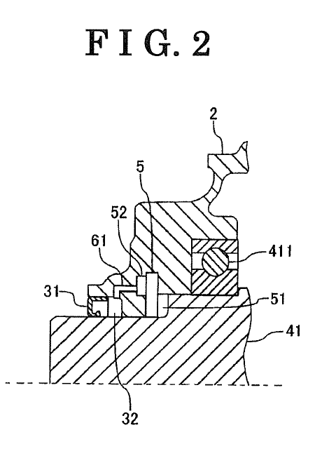

A first embodiment of a driving force distributing and transmitting apparatus 11 will be explained referring to FIGS. 1 and 2 as follows.

The driving force distributing and transmitting apparatus 11 includes a case 2 reserving lubrication fluid in a space 20 at bottom portion thereof, an input shaft 41 (i.e., serving as a rotational shaft; serving as an input shaft) receiving supply of the lubrication fluid by an input shaft oil seal 31 (i.e., serving as a first oil seal), an output shaft 42 (i.e., serving as a second output shaft; serving as a first output shaft) arranged in parallel to the input shaft 41 so as to transmit torque to front wheels, an oil pump 5 actuated by a rotation of the input shaft 41, a lubrication fluid introducing passage 61 which directly supplies pressurized lubrication fluid outputted from the oil pump 5 to the input shaft oil seal 31, and a lubrication fluid leading passage 7 which supplies the lubrication fluid that is pushed out from the input shaft oil seal 31 to other portions, or areas.

The case 2 includes a separator 21 which divides the space 20 at the bottom portion into plural spaces.

An end of the input shaft 41 protrudes to the outside from the case 2, and is supported at an upper portion of the case 2 via a bearing 411. The output shaft 42 is supported at a bottom portion of the case 2 via a bearing 421 so as to be in parallel to the input shaft 41.

The input shaft oil seal 31 is fitted between the case 2 and the input shaft 41 in the vicinity of an end portion of the input shaft 41 protruding from the case 2.

The oil pump 5 is positioned above the input shaft 41 in the vicinity of the input shaft oil seal 31 and at the case 2 at an inner side relative to the input shaft oil seal 31. The oil pump 5 includes a main path 51, which lubricates the input shaft 41, and an outlet port 52 opening to the lubrication fluid introducing passage 61 which directly supplies the lubrication fluid to the input shaft oil seal 31. Further, a pipe which establishes the communication between a lower portion of the space 20 at the bottom portion and the oil pump 5 is provided in the system, and the lubrication fluid in the space 20 at the bottom portion is sucked toward the oil pump 5 by the actuation of the oil pump 5.

The lubrication fluid introducing passage 61 establishes the communication between the outlet port 52 of the oil pump 5 and an input shaft oil seal chamber 32 which supplies lubrication fluid to the input shaft oil seal 31.

The lubrication fluid leading passage 7 is formed at an inner wall of the case 2 to be in communication with the input shaft oil seal chamber 32 of the input shaft 42. A rib 63, which receives lubrication fluid dropped from the lubrication fluid leading passage 7 by the force of gravitation and is in communication with an output shaft lubrication fluid introducing passage 62 which supplies the lubrication fluid to an output shaft oil seal chamber 33 (i.e., serving as a second oil seal) of the output shaft 42, is formed along the inner wall of the case 2 to have a gutter shape. A diameter of the rib 63 is determined to the extent which does not affect the operation of components provided in the case 2. A depth of a groove of the rib 63 is determined so as to be able to receive lubrication fluid from the lubrication fluid leading passage 7 and the lubrication fluid flows therein. The output shaft lubrication fluid introducing passage 62 is in communication with an output shaft oil seal chamber 34 which supplies the lubrication fluid to the output shaft oil seal 33.

According to the driving force distributing and transmitting apparatus 11, the input shaft 41 is rotated receiving torque from a mechanism outside of the case 2, and the inputted torque is distributed to be transmitted to the output shaft 42 and/or another output shaft. Upon the rotation of the input shaft 41, the oil pump 5 is actuated to suck the lubrication fluid reserved in the space at the bottom in the case 2. The sucked lubrication fluid is drained from the oil pump 5 to the main path 51 to lubricate the input shaft 42 and is drained from the oil pump 5 to the outlet port 52 to be supplied to the input shaft oil seal chamber 32 through the lubrication fluid introducing passage 61. The lubrication fluid supplied to the input shaft oil seal chamber 32 lubricates the input shaft oil seal 31. Because the lubrication fluid is continuously supplied from the oil pump 5 to the input shaft oil seal chamber 32 via the lubrication fluid introducing passage 61, the lubrication fluid pushed out from the input shaft oil seal chamber 32 is drained to the lubrication fluid leading passage 7 which is in communication with the input shaft oil seal chamber 32. The lubrication fluid flowing in the lubrication fluid leading passage 7 flows by the force of the gravitation to the rib 63 which is formed at the inner wall of the case 2 at the bottom portion of the case 2. The lubrication fluid flowing in the rib 63 is introduced to the output shaft lubrication fluid leading passage 62 which is in communication with the output shaft oil seal chamber 34. The lubrication fluid flowed into the output shaft lubrication fluid leading passage 62 is supplied to the output shaft oil seal chamber 34 to lubricate the output shaft oil seal 33. A direction of the lubrication fluid flowing from the lubrication fluid leading passage 7 is indicated with an arrow in FIG. 1. After lubricating the output shaft oil seal 33, eventually, the lubrication fluid is drained to the space 20 at the bottom portion to be reserved. Then, the reserved lubrication fluid is sucked by the oil pump 5 provided at the upper portion of the case by the actuation of the oil pump 5.

According to the driving force distributing and transmitting apparatus 11, by providing the lubrication fluid introducing passages which supply the lubrication fluid to the input shaft oil seal 31 and the output shaft oil seal 33, oil seal portions of known apparatuses which are unlikely to be lubricated, can be securely lubricated. Particularly, the outlet port 52 which drains the lubrication fluid from the oil pump 5 is in communication with the lubrication fluid introducing passage 61, and the lubrication fluid introducing passage 61 is in communication with the input shaft oil seal chamber 32 which supplies the lubrication fluid to the input shaft oil seal 31. Namely, a path, which directly supplies the lubrication fluid outputted from the oil pump 5 to the input shaft oil seal 31, is provided. Accordingly, because the oil seal portion, which tends to lack in the lubrication fluid, can be lubricated, sticking of the oil seal is unlikely to occur.

The oil pump 5 is actuated by the rotation of the input shaft 41, and the oil pump 5 sucks the lubrication fluid from the space 20 at the bottom portion during the rotation of the input shaft 41 to push out the lubrication fluid to the main path 51 and the outlet port 52. Accordingly, even when the driving force distributing and transmitting apparatus 11 is tilted, the oil pump 5 is actuated as long as the input shaft 41 is rotating, thus the lubrication fluid can be supplied to the input shaft oil seal 31. Accordingly, the lubrication fluid is supplied to the input shaft oil seal 31 without being affected by the tilt of the driving force distributing and transmitting apparatus 11, for example, when the vehicle drives off road. Further, because the oil pump 5 does not require an additional drive source, it is not required to provide an additional control device for the oil pump 5.

Further, because the rib 63 is formed along the inner wall of the case 2, large space is not required and also strength of the case 2 can be ensured.

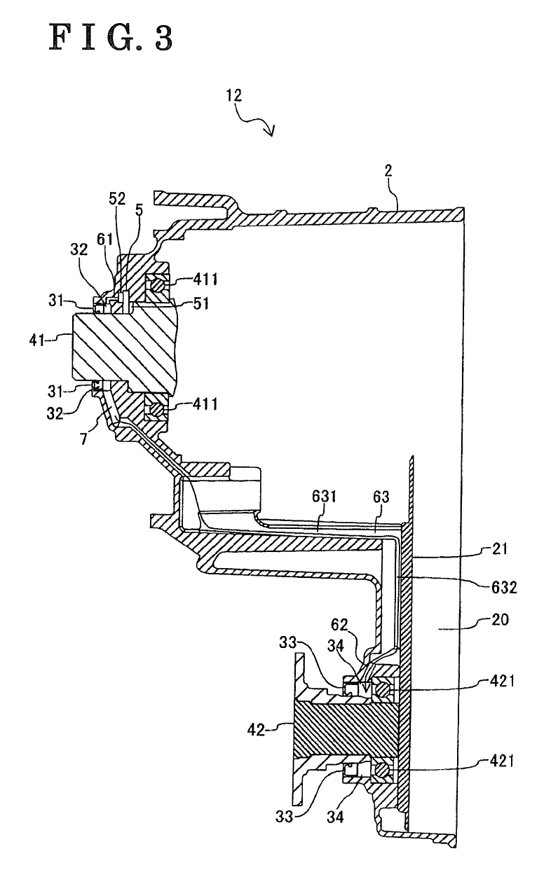

Referring to FIG. 3, a second embodiment of the present invention will be explained as follows.

As shown in FIG. 3, a position where the rib 63 is formed is partially different from the driving force distributing and transmitting apparatus 11 in the construction of a driving force distributing and transmitting apparatus 12 according to the second embodiment. Explanations for the common constructions to the first embodiment will not be repeated.

With the construction of the rib 63 applied to the driving force distributing and transmitting apparatus 12, a portion of the rib 63 is formed at the separator 21 which divides the space 20 at the bottom portion into plural spaces. In other words, the rib 63 includes an inner wall passage 631 which is formed along the inner wall of the case 2 and a separator passage 632 which is formed along the separator 21.

The lubrication fluid dropped from the lubrication fluid leading passage 7 is received by the inner wall passage 631 to flow therethrough and flows into the separator passage 632 which is in communication with the inner wall passage 631, and is introduced to the output shaft lubrication fluid introducing passage 62 from the separator passage 632.

According to the driving force distributing and transmitting apparatus 12 of the second embodiment, by forming a part of the rib 63 at the separator 21, the strength of the separator 21 can be ensured. Further, even when the passage cannot be formed at the inner wall of the case 2, a path to supply the lubrication fluid to the output shaft oil seal 33 can be ensured.

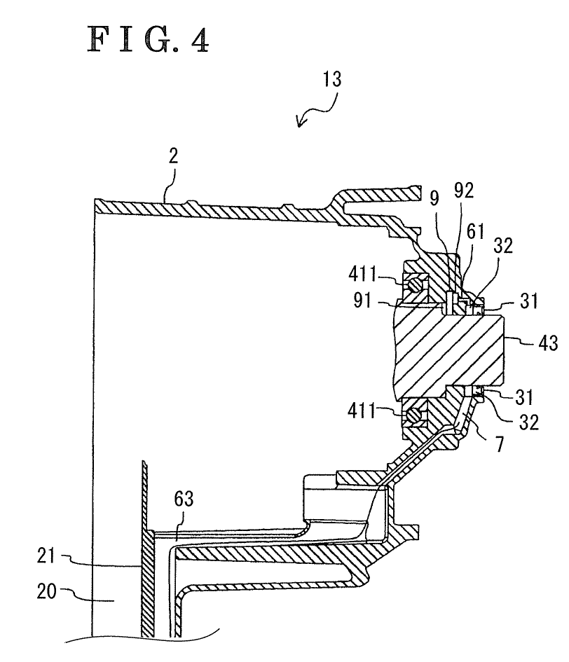

A third embodiment of the present invention will be explained with reference to FIG. 4.

With a construction of a driving force distributing and transmitting apparatus 13 according to the third embodiment of the present invention, the oil pump 5 of the driving force distributing and transmitting apparatus 11 of the first embodiment is actuated by the rotation of an output shaft 43 (i.e., serving as a rotational shaft; serving as a first output shaft; serving as a second output shaft) transmitting torque to rear wheels. Because only the operation for the actuation of the oil pump is different from the driving force distributing and transmitting apparatus 11 of the first embodiment and the constructions are common, the explanation will not be repeated.

As shown in FIG. 4, an oil pump 9 of the driving force distributing and transmitting apparatus 13 according to the third embodiment of the present invention is a gear pump.

According to the driving force distributing and transmitting apparatus 13 of the third embodiment, the lubrication fluid is sucked from the space 20 at the bottom portion to be supplied to the oil pump 9 by means of the oil pump 9, and the lubrication fluid is outputted to a main path 91, which supplies the lubrication fluid from the oil pump 9 to the input shaft 41, and to an outlet port 92, which supplies the lubrication fluid to the main path 91 and the input shaft oil seal 31.

According to the driving force distributing and transmitting apparatus 13 of the third embodiment, because the oil pump 9 is actuated by the rotation of the output shaft 43, the actuation of the oil pump 9 is not affected by the tile of the driving force distributing and transmitting apparatus 13, for example, when the vehicle drives off road. Further, the lubrication fluid can be sucked from the space 20 at the bottom portion by the rotations of gears of the oil pump 9 because of the rotation of the output shaft 43, and thus the input shaft oil seal 31 and the output shaft oil seal 33 can be lubricated.

The features of the present invention is not limited to the construction of the foregoing embodiments. For example, the rib 63 may be diverged to form a path other than a passage which is in communication with the output shaft lubrication introducing passage 62, thus to lubricate portions other than the output shaft oil seal 33. Further, by recessing a part of the passage, the vicinity of the rib 63 can be lubricated. In addition, by changing a diameter of the rib 63 to be smaller and/or shallower, the lubrication fluid may be spilled by an appropriate volume to lubricate the vicinity of the rib 63.

Further, the oil pump 5, 9 may be provided outside the case 2 as long as the rotational force of the input shaft 41 or the output shaft 43 is transmitted to actuate the oil pump 5, 9. Any types of pump can be applied as the pump 5, 9 as long as the lubrication fluid is sucked from the space 20 at the bottom portion by actuation, on the basis of the operation of the input shaft 41 or the output shaft 42, and as long as pressurizing and outputting the lubrication fluid from the pump. An electric pump actuated by an electric power may also be applied.

According to the disclosed subject matter of the driving force distributing and transmitting apparatus, the oil pump actuated by the rotation of the input shaft or output shaft outputs pressurized lubrication fluid, and the lubrication fluid outputted from the oil pump is directly supplied from the lubrication fluid introducing passage to the oil seal. Because the lubrication fluid is continuously supplied to the oil seal by the pressurization at the oil pump, the lubrication fluid lubricating the oil seal is pushed out, and the lubrication fluid pushed out from the oil seal flows from the lubrication fluid leading passage to a component to be lubricated.

According to the disclosed subject matter of the driving force distributing and transmitting apparatus, because the lubrication fluid is directly supplied to the oil seal from the lubrication fluid introducing passage, which is directly connected to the oil pump, the lubrication fluid constantly lubricates the oil seal during the actuation of the oil pump, and thus the fluid is unlikely to run out and the sticking of the oil seal is unlikely to occur. Further, because the pump is actuated in response to the rotation of the input shaft or output shaft, the lubrication fluid is outputted from the oil pump during the rotation of the input shaft or output shaft. Because being pressurized by the oil pump, the lubrication fluid is continuously pushed out from the oil seal to a component to be lubricated after lubricating the oil seal, the oil seal and the component to be lubricated can be lubricated without being affected by the tilt of the driving force distributing and transmitting apparatus.

According to the disclosed subject matter of the driving force distributing and transmitting apparatus, the lubrication fluid introducing passage can be structured as a portion of a passage which supplies the lubrication fluid to the oil seal of the output shaft. Because the passage which directly supplies the lubrication fluid to the oil seal at the output shaft is arranged, the oil seal at the output shaft is unlikely lack of lubrication fluid. The lubrication fluid outputted from the oil pump is supplied to the oil seal at the output shaft via the lubrication fluid leading passage after passing by the oil seal at the input shaft.

According to the disclosed subject matter of the driving force distributing and transmitting apparatus, the lubrication fluid leading passage may be structured as a portion of a passage which supplies the lubrication fluid from the oil seal of the output shaft to other portions. By arranging the lubrication fluid leading passage in order to lubricate the other portion other than the oil seal of the output shaft with the lubrication fluid which has lubricated the oil seal of the output shaft, the pressurized lubrication fluid outputted from the oil pump can be applied so as to lubricate each portion of the driving force distributing and transmitting apparatus.

According to the disclosed subject matter of the driving force distributing and transmitting apparatus, the gutter shaped rib is provided along either the inner wall of the case or the separator which divides the space at the bottom portion of the driving force distributing and transmitting apparatus in the plural spaces. In those constructions, when the driving force distributing and transmitting apparatus is, for example, mounted on a vehicle, the passage can be securely ensured when the driving force distributing and transmitting apparatus is tilted, for example, when the vehicle drives off road and/or when lateral gravity is generated when the vehicle makes turns.

With the construction of the driving force distributing and transmitting apparatus according to the embodiments of the present invention, because the lubrication fluid is directly supplied to the oil seal, which is likely to lack in the lubrication fluid, from the lubrication fluid introducing passage which introduces the discharge of the oil pump, the oil seal is unlikely to lack in the lubrication fluid, and thus is unlikely to stick. Further, because being pressurized by the oil pump, the lubrication fluid lubricates the oil seal and is continuously pushed out to be supplied to a component to be lubricated from the oil seal, and thus the lubrication fluid can lubricates the oil seal and the above-mentioned component to be lubricated.

With the construction of the driving force distributing and transmitting apparatus according to the embodiments of the present invention, by configuring a portion of the lubrication fluid leading passage applied in the driving force distributing and transmitting apparatus as the gutter shaped rib provided in the case, a fluid passage can be ensured even in a narrow space. Further, with the construction of the driving force distributing and transmitting apparatus according to the embodiments of the present invention, passage can be readily diverged and lubrication passages can be relatively freely determined.

With the construction of the driving force distributing and transmitting apparatus according to the embodiments of the present invention, by providing the gutter shaped rib along either the inner wall of the case or the separator which divides the space at the bottom of the driving force distributing and transmitting apparatus into the plural spaces, the gutter shaped rib can be fixed either at the inner wall of the case or the separator, and thus the passage can be securely ensured.

With the construction of the driving force distributing and transmitting apparatus according to the embodiments of the present invention, because the oil pump includes the gear pump, the gear pump is actuated in response to the actuation of the driving force distributing and transmitting apparatus, thus an additional control device for actuating and stopping the pump is not required.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A lubrication system for driving force distributing and transmitting apparatus, comprising:
a case reserving lubrication fluid in a space provided at a bottom portion thereof;
a rotational shaft rotationally supported by the case;
a first oil seal provided between the case and the rotational shaft;
an oil pump actuated by rotation of the rotational shaft;
a lubrication fluid introducing passage directly supplying the pressurized lubrication fluid outputted by the oil pump to the first oil seal; and
a lubrication fluid leading passage supplying the lubrication fluid pushed out via the first oil seal to a component to be lubricated.

2. The lubrication system for driving force distributing and transmitting apparatus according to claim 1, wherein the rotational shaft includes an input shaft or a first output shaft arranged coaxially to the input shaft.

3. The lubrication system for driving force distributing and transmitting apparatus according to claim 1, wherein the oil pump is a gear pump.

4. The lubrication system for driving force distributing and transmitting apparatus according to claim 2, wherein
the lubrication fluid introducing passage constructs a part of a passage which supplies the lubrication fluid to a second oil seal provided at a second output shaft arranged in parallel to the rotational shaft.

5. The lubrication system for driving force distributing and transmitting apparatus according to claim 2, wherein
the lubrication fluid leading passage forms a part of a passage which supplies the lubrication fluid to said component to be lubricated via a second oil seal provided at a second output shaft arranged in parallel to the rotational shaft.

6. The lubrication system for driving force distributing and transmitting apparatus according to claim 1, wherein
the lubrication fluid leading passage includes a gutter shaped rib provided in the case.

7. The lubrication system for driving force distributing and transmitting apparatus according to claim 6, wherein
wherein the gutter shaped rib is provided along an inner wall of the case and/or a separator which divides the space at the bottom portion into a plurality of spaces.

8. A lubrication system for driving force distributing and transmitting apparatus, comprising:
a case reserving lubrication fluid in a space at a bottom thereof;
an input shaft rotationally supported by the case;
a first oil seal provided between the case and the input shaft;
an oil pump actuated by rotation of the input shaft;
a lubrication fluid introducing passage directly supplying the pressurized lubrication fluid outputted by the oil pump to the first oil seal; and
a lubrication fluid leading passage supplying the lubrication fluid pushed out via the first oil seal to a component to be lubricated.

9. The lubrication system for driving force distributing and transmitting apparatus according to claim 8, wherein the oil pump is a gear pump.

10. The lubrication system for driving force distributing and transmitting apparatus according to claim 8, wherein
the lubrication fluid introducing passage constructs a part of a passage which supplies the lubrication fluid to a second oil seal provided at an output shaft arranged in parallel to the input shaft.

11. The lubrication system for driving force distributing and transmitting apparatus according to claim 8, wherein
the lubrication fluid leading passage forms a part of a passage which supplies the lubrication fluid to said component to be lubricated via a second oil seal provided at an output shaft arranged in parallel to the input shaft.

12. The lubrication system for driving force distributing and transmitting apparatus according to claim 8, wherein
the lubrication fluid leading passage includes a gutter shaped rib provided in the case.

13. The lubrication system for driving force distributing and transmitting apparatus according to claim 12, wherein
the gutter shaped rib is provided along an inner wall of the case and/or a separator which divides the space at the bottom portion into a plurality of spaces.

14. A lubrication system for a driving force distributing and transmitting apparatus, comprising:
a case reserving lubrication fluid in a space at a bottom thereof;
an input shaft rotatably supported by the case and receiving a supply of the lubrication fluid via a first oil seal;
a first output shaft rotatably supported by the case and receiving a supply of the lubrication fluid via a second oil seal;
an oil pump actuated by a rotation of the input shaft or a second output shaft;
a lubrication fluid introducing passage supplying pressurized lubrication fluid outputted from the oil pump directly to the first oil seal; and
a lubrication fluid leading passage supplying the lubrication fluid pushed out via the first oil seal to the second oil seal.

15. The lubrication system for driving force distributing and transmitting apparatus according to claim 14, wherein the oil pump is a gear pump.

16. The lubrication system for driving force distributing and transmitting apparatus according to claim 14, wherein
the lubrication fluid introducing passage constructs a part of a passage which supplies the lubrication fluid to the second oil seal provided at the first output shaft arranged in parallel to the input shaft.

17. The lubrication system for driving force distributing and transmitting apparatus according to claim 14, wherein
the lubrication fluid leading passage forms a part of a passage which supplies the lubrication fluid to a component to be lubricated via the second oil seal provided at the first output shaft arranged in parallel to the input shaft.

18. The lubrication system for driving force distributing and transmitting apparatus according to claim 14, wherein
the lubrication fluid leading passage includes a gutter shaped rib provided in the case.

19. The lubrication system for driving force distributing and transmitting apparatus according to claim 18, wherein
wherein the gutter shaped rib is provided along an inner wall of the case and/or a separator which divides the space at the bottom portion into a plurality of spaces.
